(19) United States
(12) Patent Application Publication
(10) Pub. No.: US 2009/0322671 A1
(43) Pub. Date: Dec. 31, 2009

(54) TOUCH SCREEN AUGMENTED REALITY SYSTEM AND METHOD

(75) Inventors: Katherine Scott, Ann Arbor, MI (US); Douglas Haanpaa, Dexter, MI (US); Charles J. Jacobus, Ann Arbor, MI (US)

Correspondence Address: GIFFORD, KRASS, SPRINKLE,ANDERSON & CITKOWSKI, P.C, PO BOX 7021, TROY, MI, 48007-7021, US

(73) Assignee: Cybernet Systems Corporation, Ann Arbor, MI (US)

(21) Appl. No.: 12/478,526

(22) Filed: Jun. 4, 2009

Related U.S. Application Data
(60) Provisional application No. 61/058,759, filed on Jun. 4, 2008.

(51) Int. Cl. G09G 5/00; G06K 9/00; G06F 3/041

(52) U.S. Cl. 345/156; 382/103; 345/173

(57) ABSTRACT

An improved augmented reality (AR) system integrates a human interface and computing system into a single, hand-held device. A touch-screen display and a rear-mounted camera allows a user interact the AR content in a more intuitive way. A database storing graphical images or textual information about objects to be augmented. A processor is operative to analyze the imagery from the camera to locate one or more fiducials associated with a real object, determine the pose of the camera based upon the position or orientation of the fiducials, search the database to find Graphical images or textual information associated with the real object, and display graphical images or textual information in overlying registration with the imagery from the camera.

### REFERENCE TO RELATED APPLICATION

This application claims priority from U.S. Provisional Patent Application Ser. No. 61/058,759, filed Jun. 4, 2008, the entire content of which is incorporated by reference.

### GOVERNMENT SUPPORT

This invention was made with Government support under Contract No. M67854-07-C-6526 awarded jointly by the United States Navy and United States Marine Corps. The Government has certain rights in the invention.

### FIELD OF INVENTION

This invention relates generally to augmented reality and, in particular, to a self-contained, augmented reality system and method for educational and maintenance applications.

### BACKGROUND OF TE INVENTION

Delivering spatially relevant information and training about real-world objects is a difficult task that usually requires the supervision of an instructor or individual with in-depth knowledge of the object in questions. Computers and books can also provide this information, but it is delivered in a context outside of the object itself.

Augmented reality—the real-time registration of 2D or 3D computer imagery onto live video—is one way of delivering spatially relevant information to the context of an object. Augmented Reality Systems (ARS) use video cameras and other sensor modalities to reconstruct the camera's position and orientation (pose) in the world and recognize the pose of objects for augmentation. This pose information is then used to generate synthetic imagery that is properly registered (aligned) to the world as viewed by the camera. The end user is the able to view and interact with this augmented imagery in such a way as to provide additional information about the objects in their view, or the world around them.

Augmented reality systems have been proposed to improve the performance of maintenance tasks, enhance healthcare diagnostics, improve situational awareness, and create training simulations for military and law enforcement training. The main limitation preventing the widespread adoption of augmented reality systems for training maintenance and healthcare are the costs associated with head mounted displays and the lack of intuitive user interfaces.

Current ARS often require costly and disorientating head mounted displays, force the user to interact with AR environment using a keyboard and mouse, or a vocabulary of simply hand gestures, and require the user to be harnessed to a computing platform, or relegated to augmented arena. The ideal AR system would provide the user with a window to the augmented world, where they can freely move around the environment and interact with augmented objects by simply touching the augmented object in the display window. Since existing systems rely on a head-mounted display, they are only useful for a single individual.

The need for low-cost, simplicity, and usability drive the design and specification of ARS for maintenance and information systems. Such a system should be portable with a large screen and a user interface that allows the user to quickly examine and add augmented elements to the augmented reality environments. For maintenance tasks these systems should be able to seamlessly switch between the augmented environment and other computing applications used for maintenance or educational purposes. To provide adequate realism of the augmented environment the computing platform ARS must be able to resolve pose values at rates similar to those at which a human would be able to manipulate the computing device.

### SUMMARY OF THE INVENTION

This invention improves upon augmented reality systems by integrating an augmented reality interface and computing system into a single, hand-held device. Using a touch-screen display and a rear-mounted camera, the system allows the user to use the AR display as necessary and interact the AR content in a more intuitive way. The device essentially acts as the user's window on the augmented environment from which they can select views and touch interactive objects in the AR window.

An augmented reality system according to the invention includes a tablet computer with a display and a database storing graphical images or textual information about objects to be augmented. A camera is mounted on the computer to view a real object, and a processor within the computer is operative to analyze the imagery from the camera to locate one or more fiducials associated with the real object; determine the pose of the camera based upon the position or orientation of the fiducials; search the database to find graphical images or textual information associated with the real object; and display graphical images or textual information in overlying registration with the imagery from the camera.

The database may include a computer graphics rendering environment with the object to be augmented seen from a virtual camera, with the processor being further operative to register the environment seen by the virtual camera with the imagery from the camera viewing the real object. The graphical images or textual information displayed in overlying registration with the imagery from the camera may be two-dimensional or three-dimensional. Such information may include schematics or CAD drawings. The imagery from the camera may be presented by projecting three-dimensional scene annotation onto a two-dimensional display screen. The display may be constructed by estimating where a point on the two-dimensional display screen would project into a three-dimensional scene.

The graphical images or textual information includes written instructions, video, audio, or other relevant content. The database may further stores audio information relating to the object being imaged. The pose may include position and orientation.

The camera may be mounted on the backside of the tablet computer, or the system may include a detachable camera to present overhead or tight space views. The system may further including an inertial measurement unit to update the pose if the tablet is moved to a new location. The pose data determined by the inertial measurement unit may be fused with the camera pose data to correct, or improve the overall pose estimate. In the preferred embodiment, the inertial measurement unit includes three accelerometers and three gyroscopes. The display is preferably a touch-screen display to accept user commands.

The system may further include a camera oriented toward a user viewing the display to track head or eye movements. An infrared or visible light-emitted unit may be worn by a user, with the camera being operative to image the light to track user head or eye movements. The processor may be further operative to alter the perspective of displayed information as a function of a user's view.

### BRIEF DESCRIPTION OF THE DRAWINGS

FIG. 1 is a block diagram of an augmented reality system according to the invention;

FIG. 2A is a perspective view of the portable, hand-held device;

FIG. 2B is a front view of the device;

FIG. 2C is a back view of the device;

FIG. 2D is a side view of the device;

FIG. 3 shows an example of an application of the augmented reality system;

FIG. 4A shows a general view of a transmission example of how head tracking can be used in an augmented reality device with rear mounted camera;

FIG. 4B shows the transmission augmented with a diagram of the internal components;

FIG. 4C shows the user's head moves to the right with respect to the screen the augmented view follows the user's change in orientation, allowing for improved depth perception of the internal structures;

FIG. 4D shows the user's head moves similar to FIG. 4C but the rotation of the user's head is in the other direction;

FIG. 5A shows a user with safety glasses with fiducials used for head tracking;

FIG. 5B is an example of head tracking using the forward looking camera;

FIG. 5C illustrates gesture recognition as a means of augmented reality control; and

FIG. 5D shows touch-screen control of the augmented reality system.

### DETAILED DESCRIPTION OF INVENTION

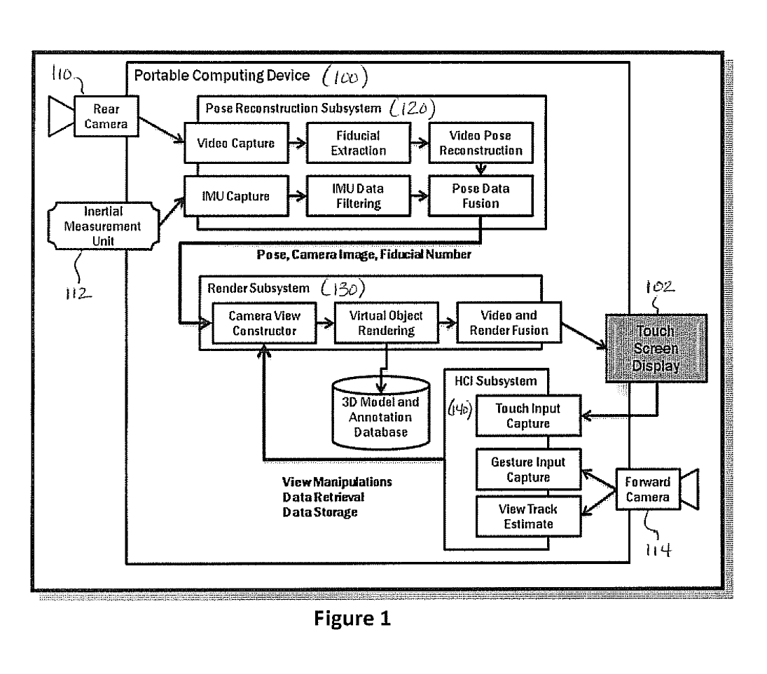

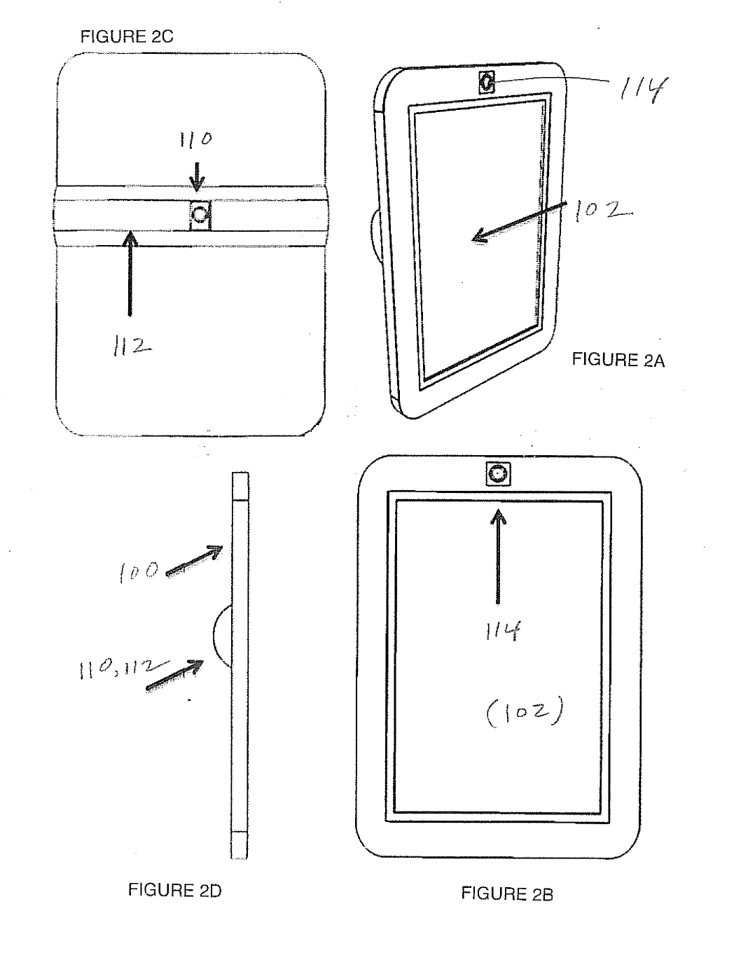

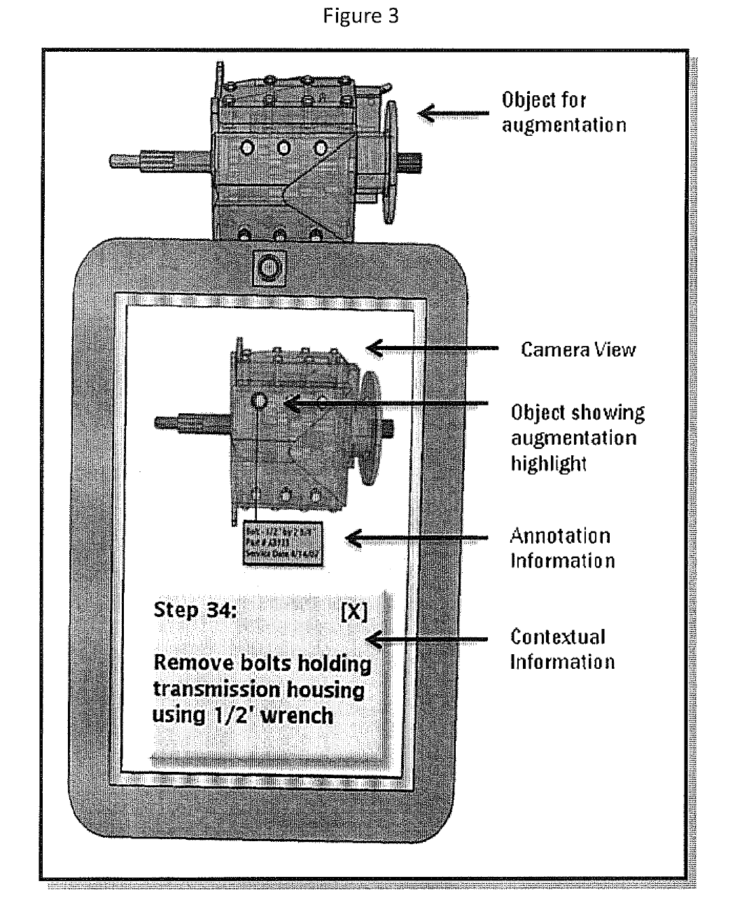

Existing Augmented Reality System (ARS) technology is limited by the number of high-cost components required to render the desired level of registration. Referring to FIG. 1, we have overcome this limitation by replacing the traditional head-mounted display with a touch-screen display attached to a portable computing device 100 with integrated sensors. In the preferred embodiment, a rear-mounted, high-speed camera 110 and MEMs-based three-axis rotation and acceleration sensor (inertial measurement unit 112) are also integrated into the hand-held device. A camera 114 may also be mounted to the front of the device (the side with the touch screen) for the purpose of face tracking and gesture recognition. FIGS. 2A-D provide different views of a physically implementation of the device.

The augmentation process typically proceeds as follows using the device.

1) First, the rear-mounted camera extracts fiducials from the augmented object. This fiducial information can be human generated information like a barcode or a symbol, or in the form of a set of natural image features.

2) The extracted fiducial is the used to retrieve a 3D model of the environment or augmented object from a database; additional information about the object or area (like measurement data, relevant technical manuals, textual annotations (like last repair date) can also be stored in this database. This annotation data can associated with the object as a whole, or it may be associated with a particular range of view angles. Concurrently, the fiducial information is used to reconstruct the camera's pose with respect to the tracked area or object.

3) The pose data estimated in the previous step is used to create a virtual camera view in a 3D computer simulation environment. Given a set of user preferences, the simulation renders the 3D model of the object along with any additional annotation data. This simulated view is then blended with incoming camera data to create an image that is the mixture of both the camera view and the synthetic imagery. This imagery is rendered to the touch screen display.

4) As the user moves around the object new camera poses are estimated by fusing data from the camera imagery and the inertial measurement unit to determine an optimal estimate of the unit's pose. These new poses are used to affect the virtual camera of the 3D simulation environment. As the device's pose is changed new annotation information may also become available. Particularly if the fiducial information is derived from a predetermined type of computer-readable code, the size and/or distortion of code may be used to determine not only the initial pose of the system but also subsequent pose information without the need for the inertial measurement unit. Of course, the computer-readable code may also be interpreted to retrieve relevant information stored in the database.

5) The touch screen display is used to modify the view of the virtual object and interact or add additional annotation data. For example, sub-components of the object can be highlighted and manipulated by touching the region of the screen displaying the component or by tracing a bounding box around the component.

6) The front-mounted camera is used to track the user's view angle by placing to fiducials near the eyes (for example light emitting diodes mounted on safety glasses). By tracking these fiducials, the user can manipulate the virtual camera view to affect different views of the virtual objects (essentially change the registration angle of the device, while the background remains static).

7) The front-mounted camera can also be used to perform gesture recognition to serve as a secondary user interface device. The recognized gestures can be used retrieve specific annotation data, or modify the virtual camera's position and orientation.

The embedded inertial measurement unit (IMU) is capable of capturing three axis of acceleration and three axis of rotational change. The IMU may also contain a magnetometer to determine the Earth's magnetic north. The front-mounted camera 114 is optional, but can be used to enhance the user's interaction with the ARS system.

The live video feed from camera 110 and inertial measurement data are fed through the pose reconstruction software subsystem 120 shown in FIG. 1. This subsystem searches for both man-made and naturally occurring image features to determine the object or area in view, and then attempts to reconstruct the position and orientation (pose) of the camera using only video data. The video pose information is then fused with the inertial measurement system data to accurately reconstruct the camera/devices position with respect to the object or environment. The resulting data is then filtered to reduce jitter and provide smooth transitions between the estimated poses.

After the pose reconstruction software subsystem 120 has determined a pose estimate this data is then fed into a render subsystem 130 that creates a virtual camera view within a 3D software modeling environment. The virtual camera view initially replicates the pose extracted from the pose reconstruction subsystem. The fiducial information date derived from the reconstruction software subsystem is used to retrieve a 3D model of the object or environment to be augmented along with additional contextual information. The render subsystem generates a 3D view of the virtual model along with associated context and annotation data.

Assuming that the average touch screen computing platform weighs about 2 Kg, and has dimensions of around 30 cm by 25 cm, we estimate that under normal use the unit will undergo translations of no more than 1.3 m/s of translation and 90 degrees/s of translation. Furthermore we believe that good AR registration must be less than one degree and less than 5 mm off from the true position of the augmented objects. We believe that this level of resolution that this level of resolution is possible with a camera system running at 120 FPS and an accelerometer with a sample frequency exceeding 300 Hz.

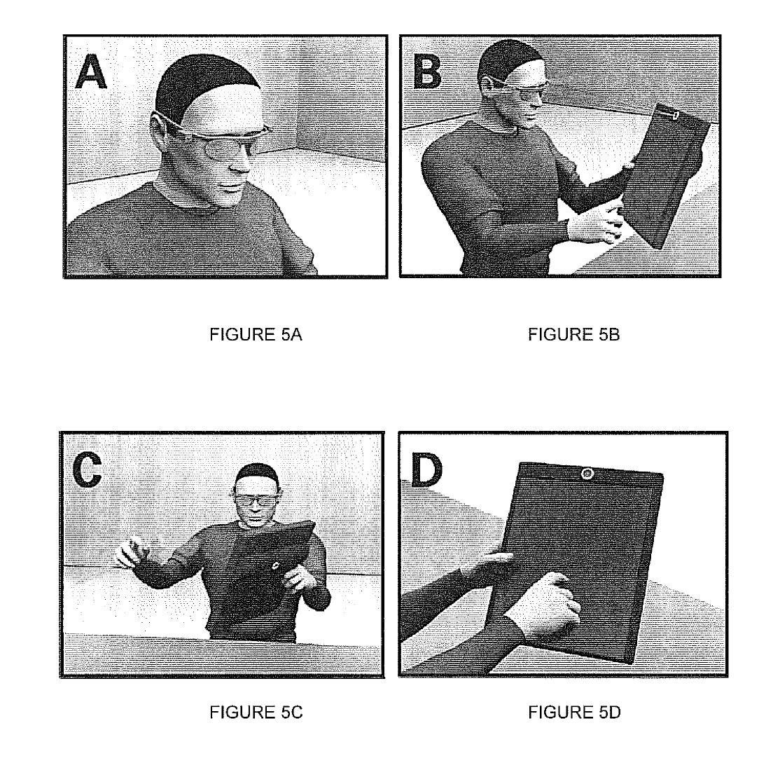

Concurrent to the pose reconstruction process, a front-mounted camera may be used to perform head tracking (FIG. 1, HCI Subsystem 140). The head tracker looks for two fiducials mounted near the user's eyes. These fiducials can be unique visual elements (fiducials) or light sources like light emitting diodes (LEDs). The fiducials are used to determine the head's position and orientation with respect to the touch screen (FIGS. 5A, 5B). This head pose data can then be used to modify the view of the augmented space or object.

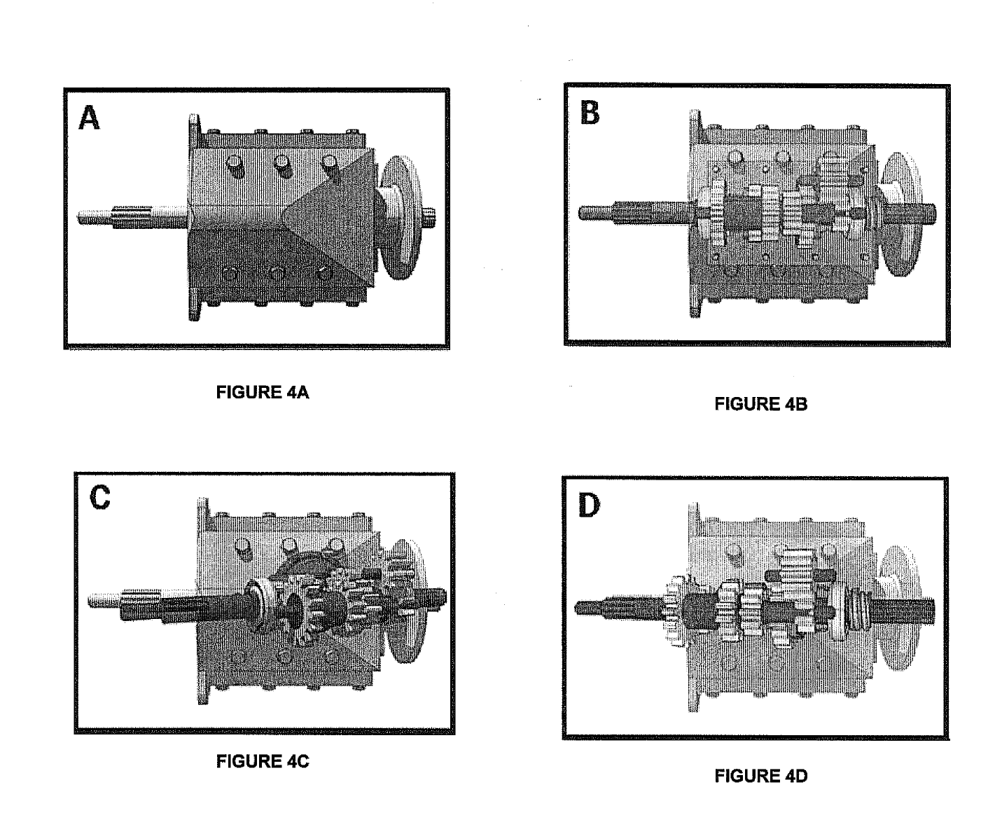

FIG. 4A is a general view of a transmission example, showing how head tracking can be used in an augmented reality device with the rear mounted camera. FIG. 4B shows the transmission augmented with a diagram of the internal components. FIG. 4C shows the user's head moves to the right with respect to the screen the augmented view follows the user's change in orientation, allowing for improved depth perception of the internal structures. FIG. 4D shows the user's head moves similar to FIG. 4C but the rotation of the user's head is in the other direction.

The forward camera 114 can also be used to recognize objects and specific gestures that can be associated with augmented object interactions (FIG. 5C). The touch input capture module of the HCI subsystem is used to take touch screen input and project that information in the 3D rendering environment. This touch screen input can be used to input annotations or interact with the 3D model, annotations, or other contextual information (FIG. 5D). The HCI subsystem performs any data processing necessary to translate user input actions into high level rendering commands.

The HCI information from the HCI subsystem, screen touch locations, HCI actions (gestures, both touch and from the camera), and head tracking pose, are then fed into the render subsystem. These control inputs, along with the video data from the rear mounted camera, and the 3D model annotation, and contextual information are then rendered to the touch screen in such a way as to blend with the live

The invention offers numerous advantages over traditional augmented reality systems. Our approach presents a single integrated device that can be ruggedized for industrial applications, and ported to any location. The touch screen and gesture recognition capabilities allow the user to interact with the system in an intuitive manner without the need for computer peripherals. The view tracking system is novel as ARS systems normally focus on perfect registration, while our system uses the register component as a starting point for additional interaction.

Since there is no head-mounted display (HMD), there is no obstruction of the user's field of view (FOV). Most head mounted displays support a very narrow field of view (e.g. a diagonal FOV of 45 degrees). Whereas HMD based systems must be worn constantly, our approach allows the user to use the AR system to gain information and then stow it to use their normal field of view.

Most HMD based AR systems require novel user input methods. The system must either anticipate the user's needs or gain interactive data using an eye tracking system or tracking of the user's hands (usually using an additional set of fiducials). Our touch screen approach allows the user to simple touch or point at the object they wish to receive information about. We feel that this user input method is much more intuitive for the end-user.

Because out system does not require an HMD there are fewer cables to break or become tangled. The AR system functions as a tool (like a hammer) rather than a complex arrangement of parts. HMD AR systems must be worn constantly and can degrade the user's depth perception, peripheral vision, and cause disorientation because of system latency. Unlike other ARS currently under development, our ARS approach allows the user to interact with the AR environment only when he or she needs it.

Whereas HMD based AR systems are specifically geared to a single user our approach allows multiple users to examine the same augmented view of an area. This facilitates human collaboration and allows a single AR system to be used by multiple users simultaneously.

### ADDITIONAL EMBODIMENTS

This technology was originally developed to assist mechanics in the repair and maintenance of military vehicles but it can be utilized for automotive, medical, facility maintenance, manufacturing, retail, applications. The proposed technology is particularly suited to cellular phone and personal digital assistant (PDA) technologies. Our simplified approach to augmented reality allows individuals to quickly and easily access three-dimensional, contextual, and annotation data about specific objects or areas. The technology may be used to render 3D medical imagery (magnetic resonance imagery, ultrasound, and tomography) directly over the area scanned on a patient. For medical training this technology could be used to render anatomical and physiological objects inside of a medical mannequin.

In the case of maintenance this technology can be used to link individual components directly to technical manuals, requisition forms, and maintenance logs. This technology also allows individuals to view the 3D shape and configuration of a component before removing it from a larger assembly. In the case of building maintenance fiducials could be used to record and recall conduits use for heat/cooling, telecommunication, electricity, water, and other fluid or gas delivery systems. In retail setting this technology could deliver contextual data about particular products being sold.

When applied to cellular phones or PDAs this technology could be used to save and recall spatially relevant data. For example a fiducial located on the façade of a restaurant could be augmented with reviews, menus, and prices; or fiducials located on road signs could be used to generate correctly registered arrows for a mapped path of travel.

We claim:

1. An augmented reality system, comprising:
a tablet computer with a display and a database storing graphical images or textual information about objects to be augmented;
a camera mounted on the computer to view a real object; and
a processor operative to perform the following functions:
a) analyze the imagery from the camera to locate one or more fiducials associated with the real object,
b) determine the pose of the camera based upon the position or orientation of the fiducials,
c) search the database to find graphical images or textual information associated with the real object, and
d) display graphical images or textual information in overlying registration with the imagery from the camera.

2. The augmented reality system of claim 1, wherein:
the database includes a computer graphics rendering environment including the object to be augmented as seen from a virtual camera; and
the processor is further operative to register the environment seen by the virtual camera with the imagery from the camera viewing the real object.

3. The augmented reality system of claim 1, wherein the graphical images. or textual information displayed in overlying registration with the imagery from the camera are two-dimensional or three-dimensional.

4. The augmented reality system of claim 1, wherein the graphical images or textual information displayed in overlying registration with the imagery from the camera include schematics or CAD drawings.

5. The augmented reality system of claim 1, wherein the graphical images or textual information are displayed in overlying registration with the imagery from the camera by projecting three-dimensional scene annotation onto a two-dimensional display screen.

6. The augmented reality system of claim 1, wherein the graphical images or textual information are displayed in overlying registration with the imagery from the camera by estimating where a point on the two-dimensional display screen would project into the three-dimensional scene.

7. The augmented reality system of claim 1, wherein the graphical images or textual information includes written instructions, video, audio, or other relevant content.

8. The augmented reality system of claim 1, wherein the database further stores audio information relating to the object being imaged.

9. The augmented reality system of claim 1, wherein the pose includes position and orientation.

10. The augmented reality system of claim 1, wherein the camera is mounted on the backside of the tablet computer.

11. The augmented reality system of claim 1, further including a detachable camera to present overhead or tight space views.

12. The augmented reality system of claim 1, further including an inertial measurement unit to update the pose if the tablet is moved to a new location.

13. The augmented reality system of claim 1, further including an inertial measurement unit outputting pose data that is fused with the camera pose data to correct, or improve the overall pose estimate.

14. The augmented reality system of claim 1, further including an inertial measurement unit with three accelerometers and three gyroscopes to update the pose if the tablet is moved to a new location.

15. The augmented reality system of claim 1, wherein the display is a touch-screen display to accept user commands.

16. The augmented reality system of claim 1, further including a camera oriented toward a user viewing the display to track head or eye movements.

17. The augmented reality system of claim 1, further including:
a light-emitted unit worn by a user; and
a camera operative to image the light to track user head or eye movements.

18. The augmented reality system of claim 1, further including:
a camera oriented toward a user viewing the display to track head or eye movements; and
wherein the processor is further operative to alter the perspective of displayed information as a function of a user's view.

19. The augmented reality system of claim 1, wherein:
the display includes a touch screen; and
a user is able to manipulate a displayed 3D model by selecting points on the touch screen and having these points project back into the 3D model.

20. The augmented reality system of claim 1, wherein a user is able to associate annotation data with the 3D model and a range of poses of the computing device to affect augmented annotation.
